(19) United States
(12) Patent Application Publication
(10) Pub. No.: US 2012/0142511 A1
(43) Pub. Date: Jun. 7, 2012

(54) Cross grain folder and method of folding including an extended lap

(75) Inventors: Jackson Hacker Jones, Rochester, NH (US); John Sheridan Richards, Barrington, NH (US)

(73) Assignee: GOSS INTERNATIONAL AMERICAS, INC., Dover, NH (US)

(21) Appl. No.: 12/927,993

(22) Filed: Dec. 1, 2010

(51) Int. Cl. B31F 1/10

(52) U.S. Cl. 493/435

(57) ABSTRACT

An apparatus includes a quarterfolder having a folding blade for folding newspapers or other products. A folding location of the quarterfolder being adjustable with respect to the newspapers. The folding location may, for example, be located at between about 10 inches and about 11 inches from an edge of the newspaper so as to create a newspaper having a first side with a height of at between about 10 inches and about 11 inches and a second side with a height of approximately 9 inches or less. The second side, may, for example, have a height of between about 1 inch and about 2 inches, or alternatively, between about 7 inches and about 8 inches, depending on the overall length of the newspaper.

The present invention relates generally to printing presses and more particularly to folders and quarterfolders in a printing press.

### BACKGROUND

U.S. Pat. No. 4,509,939 discloses a folding device for a web-fed rotary printing press for forming a longitudinal fold in a direction wherein printed copies are conveyed, the longitudinal fold being producible, after a cylinder-crossfold, by a folding blade disposed parallel to the conveying direction.

U.S. Pat. No. 6,139,003 discloses a method and a device for producing multi-layered newspaper with so-called tabloid sections. A number of paper webs, which number is variable, is admixed to the one or more webs that are provided with a longitudinal separation cut and which are fed to the one longitudinal former.

U.S. Pat. No. 6,551,228 discloses a quarterfold folding device and method. Signatures in a stream of signatures are delayed to form signature groupings, each as signature pairs, which are then folded via an appropriately sized chopper blade or folding blade.

U.S. Patent Application Publication No. 2007/0221076 discloses a 3 by 2 tabloid printing press that includes a plate cylinder having a straight across lock-up and a blanket cylinder contacting the plate cylinder; a blanket cylinder printing a web; and a folder superstructure having at least one slitter for slitting the web into three ribbons and a folder for forming a tabloid newspaper from the three ribbons.

U.S. Patent Application Publication No. 2007/0261576 purportedly discloses an upright arrangement of tabloid pages on a form cylinder so the back of the tabloid book to be produced is formed via the folding funnel during longitudinal folding. A transverse fold is no longer required. The tabloid books are obtained through transverse cutting and a former fold.

The newspaper industry has been affected by an increasing cost of newsprint. A broadsheet newspaper format typically includes dimensions of approximately 22 inches in height (11 inches when folded) and 15 inches in width. Often, broadsheet newspapers are folded over in half for transport or display in news racks or news stands. Many broadsheet newspaper formats have converted to a narrower width, for example, 12 inches, or changed over to a tabloid format to save on newsprint costs.

A tabloid newspaper format typically includes dimensions of approximately 12 to 20 inches in height and approximately 10 to 12 inches in width. Typically, the width of a tabloid newspaper depends upon the circumference of the printing plate cylinder and the height of a tabloid newspaper is dependent upon the web width and/or slitting of the web. Often times, tabloid newspapers do not include separate sections and thus, tabloid newspapers are formed in straight mode, as opposed to collect mode.

### BRIEF SUMMARY OF THE INVENTION

Typically, tabloid newspapers are formed by printing a web or webs with images. The webs are run into a folder, gathered together and slit into ribbons and passed over a former. The combined ribbons are then cut into newspapers. The newspapers are then passed to a cylinder and transversely folded in half. This transverse fold in the tabloid newspaper forms the spine of the tabloid newspaper in western countries. The fold is on the left when viewing the front page of a tabloid newspaper. The newspaper may be folded a second time, quarterfolded, after the cylinder fold is made in the tabloid newspaper. The quarterfold is made in a direction perpendicular to the transverse cylinder fold.

Quarterfolders in newspaper printing presses are designed to fold a newspaper generally in half. The quarterfold may not be located precisely at the geometric center point, however, the newspaper is folded approximately in half. For example, after being quarterfolded, a newspaper having a height of 16 inches would have a fold at approximately 8.0 inches from the top or bottom edge. Any shortening of one half with respect to the other to produce a lap in a current quarterfolder is limited. The newspaper may be quarterfolded in a way to accommodate for minor adjustments in post-press operations. Typical quarterfolders do not fold a newspaper so one side of the newspaper is longer than the other side, for example, the area above the fold being 10.5 inches long, while the area below the fold being 8.0 inches in length.

During subsequent finishing operations, inserts may be placed in the newspaper which rest on the quarterfold or between the quarterfolded pages of the newspaper. When tabloid newspapers are quarterfolded, some of the standard-sized inserts protrude out of the top of the newspapers. Inserts also may be placed into plastic packaging then inserted into the tabloid newspaper. The additional plastic packaging adds costs to the finishing process and the inserted pack often sticks out above the front page of the tabloid newspaper which is undesirable.

An object of the present invention provides imparting a quarterfold into a tabloid newspaper in such a way that the area above the fold is different from the area below the fold and using the same quarterfolder to impart a typical quarterfold where the areas above and below the fold are the same when desired or necessary.

A further object of the invention provides tabloid format newspapers that have been quarterfolded into a small broadsheet. The total height of the tabloid format newspaper may be, for example, 18.5 inches or 14.67 inches. However, the tabloid newspapers are quarterfolded so a face of the resulting small broadsheet newspaper has a height of, for example, 10.5 inches. The shorter newspaper thus advantageously retains the appearance of the newspaper and prevents inserts or other internal newspaper components from sticking out above the front page of the newspaper.

In accordance with an embodiment of the present invention, an apparatus for imparting a fold to a printed product (preferably a quarterfold to a newspaper) is provided which includes a conveyor conveying a printed product in a path, the printed product having a centerpoint along a length of the printed product extending in a direction perpendicular to the path; a folding blade for folding the printed product along a fold which is parallel to a direction of the path; and a pair of folding cylinders for receiving the printed product folded by the folding blade. The folding blade and folding cylinders are positioned with respect to the path so that the fold is offset from the centerpoint by at least 2.5% of the length, and no more than about 45% of the length. In this regard, if the length of a newspaper to be folded is 12 inches, the fold may, for example, be offset from the centerpoint by at least 1 inch and no more than about 5 inches, and preferably between at least 3 inches and no more than about 5 inches. If the length of the newspaper is between about 14 inches and about 15 inches, the fold may, for example, be offset from the centerpoint by at least 1 inch and no more than about 5 inches, and preferably by at least 2 inches and no more than about 3 inches. If the length of the newspaper is between about 18 inches and about 20 inches, the fold may, fore example, be offset from the centerpoint by at least 0.5 inches and no more than about 9 inches.

In accordance with another embodiment of the present invention, a newspaper printing press includes at least one print unit printing at least one web of material and a folder. The folder includes a cross folder for forming a cross-fold in the newspapers, and a quarterfolder having a folding blade. The quarterfolder receives the cross-folded newspapers at the cross-fold, and a folding location of the quarterfolder being adjustable with respect to the cross-folded newspapers. In this regard the folding location may be located at between about 10 inches and about 11 inches from an edge of the newspaper so as to create a newspaper having a first side with a height of at between about 10 inches and about 11 inches and a second side with a height of approximately 9 inches or less. The second side may, for example, have a height of between about 1 inch and about 2 inches, or alternatively, between about 7 inches and about 8 inches, depending on the overall length of the newspaper. The cross folder can, for example, comprise a collect cylinder and folding (for example, jaw) cylinder for forming a cross fold, or can be comprised of a rotary blade folder for forming a cross fold.

In accordance with another embodiment of the present invention, a quarterfolder for a printing press is provided which includes a conveyor conveying newspapers in a path; a folding blade for folding the newspapers along a fold which is parallel to a direction of the path; and a pair of folding cylinders for receiving the newspapers folded by the folding blade. The folding blade and folding cylinders are adjustable with respect to the newspaper path so the folding blade is capable of selectively quarterfolding the newspapers at a center thereof and at an adjustable offset from the center thereof.

In accordance with another embodiment of the present invention, a method for forming a newspaper comprising the steps of cross-folding a newspaper at a cross fold approximately in half; quarterfolding the cross-folded newspaper with a folding blade at a quarterfold to create a newspaper having a first side having a predetermined first length from the quarterfold to an edge of the newspaper and a second side having a predetermined second length from the quarterfold to another edge of the newspaper, a ratio of the first length to the second length being at least 10.5 to 8.50.

In accordance with another embodiment of the present invention, a method for forming a newspaper comprising the steps of: cross-folding a newspaper at a cross fold approximately in half; and quarterfolding the cross-folded newspaper with a folding blade at a quarterfold, the quarterfold being approximately 10.5 inches from an edge of the newspaper so as to create a newspaper having a first side with a length of at least approximately 10.5 inches and a second side with a height of approximately 8.50 inches or less.

In accordance with another embodiment of the present invention an offset quarterfolded broadsheet newspaper comprises a longitudinal first fold located at a first fold location, the longitudinal first fold folding the newspaper in two approximately equal parts; a cross fold located at a cross fold location, the cross fold location being offset from a center of the longitudinally first folded newspaper, the cross fold folding the newspaper in two unequal parts; and a quarterfold located at a quarterfold location, the quarterfold location being offset from a center of the cross-folded newspaper, the quarterfold folding the newspaper in two unequal parts.

### BRIEF DESCRIPTION OF THE DRAWINGS

Preferred embodiments of the present invention will be elucidated with reference to the following drawings, in which:

FIG. 1 shows a tabloid printing press having a folder section including a quarterfolder device according to the present invention;

FIG. 2 shows a quarterfolder device in accordance with the prior art;

FIGS. 3A to 3C show the quarterfolder device shown in FIG. 1 quarterfolding a tabloid newspaper according to the present invention;

FIGS. 4A to 4C schematically show newspapers quarterfolded according to the present invention;

FIG. 5A shows a folder arrangement in accordance with the prior art;

FIG. 5B shows a folder arrangement in accordance with the present invention;

FIGS. 5C and 6A show further preferred folder arrangements according to the present invention;

FIG. 7A shows a broadsheet tabloid printing press having a folder section including a quarterfolder device according to a further preferred embodiment of the present invention;

FIG. 7B shows a folder arrangement for the printing press in FIG. 7A; and

FIGS. 8A and 8B show newspapers quarterfolded in accordance with a further preferred embodiment of the present invention.

### DETAILED DESCRIPTION OF PREFERRED EMBODIMENTS

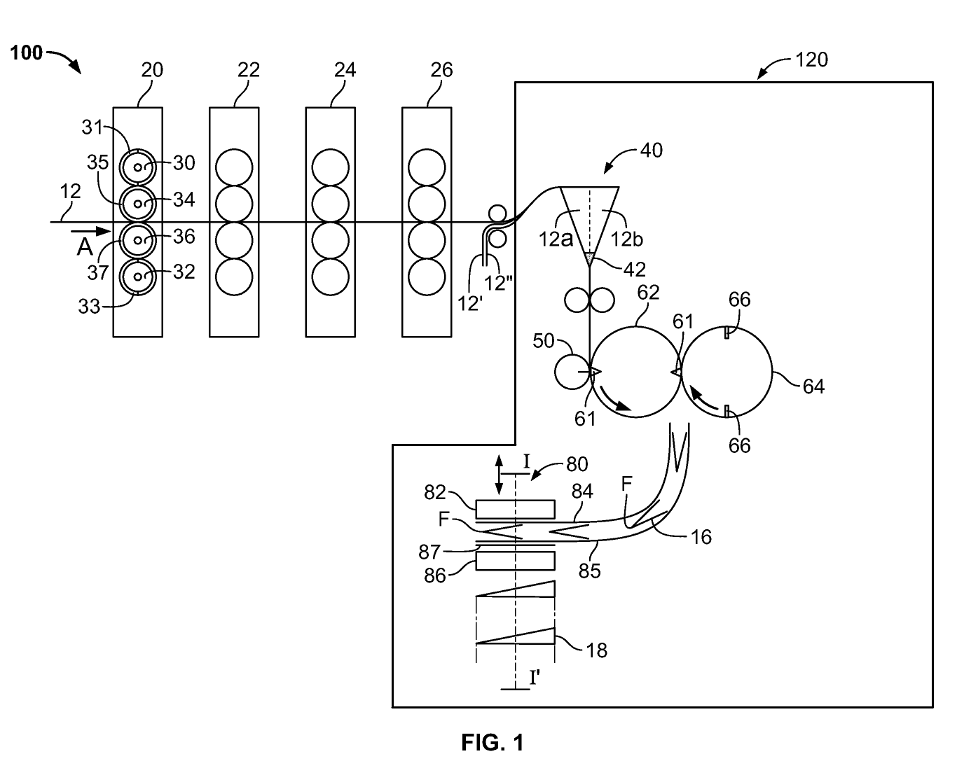

FIG. 1 shows a printing press 100 including a folder section 120 and a quarterfolding device 80 for printing tabloid newspapers in accordance with the present invention. The tabloid printing press 100 may be a perfecting, web offset, four color printing press. Printing press 100 may include four printing units 20, 22, 24, 26 each printing on a web 12 with a different color ink, for example, cyan, magenta, yellow and black. Web 12 travels through press 100 in a direction A from printing unit 20 to folder section 120. Each printing unit 20, 22, 24, 26 includes two printing cylinders 30, 32 and two blanket cylinders 34, 36. Each printing cylinder 30, 32 carries a printing plate 31, 33 mounted thereon. Alternatively, the printing cylinders 30, 32 may be etched or imaged directly with a printing image. Each blanket cylinder 34, 36 includes a printing blanket 35, 37 mounted thereon. The printing blankets 35, 37 may be flat blankets mounted into a lockup mechanism or printing blankets 35, 37 may be tubular, gapless, sleeve-shaped blankets. The printing plates 31, 33 transfer images to printing blankets 35, 37 which transfer images to web 12.

The configuration and geometry of printing cylinders 30, 32 and blanket cylinders 34, 36 may be varied as desired and may include, for example, one around printing cylinders (each printing cylinder having one printing plate mounted thereon), two around printing cylinders or three around printing cylinders, the two and three around printing cylinders may carry a single printing plate having multiple images or multiple printing plates, or any combination thereof. Printing plates and blankets 31, 33, 35, 37 may include multiple images across their width.

From the printing section, web 12 then enters folder section 120. Folder section 120 includes a triangular shaped former 40 for folding and slitting web 12 into ribbons 12a, 12b. Web 12 may also be combined with other web ribbons 12′, 12″ for simultaneous folding and slitting. Ribbons 12′, 12″ may be printed by another printing section or by another printing press. Former 40 folds web 12 in half as web 12 runs down a surface of former 40. A slitter 42 on a nose of former 40 slits web 12 into two ribbons 12a, 12b. Web 12 is slit in half longitudinally, in the direction of travel. The two ribbons 12a, 12b are combined and continue downstream.

A cross cutter 50 then cuts ribbons into broadsheet newspaper pages which are gripped at a lead edge by a collect cylinder 62. The collect cylinder 62 has pins that selectively articulate to release a page for cross-folding, or retain a page to collect with other pages. Newspapers 92 are then tucked and cross-folded into a folding cylinder, for example, jaw cylinder 64.

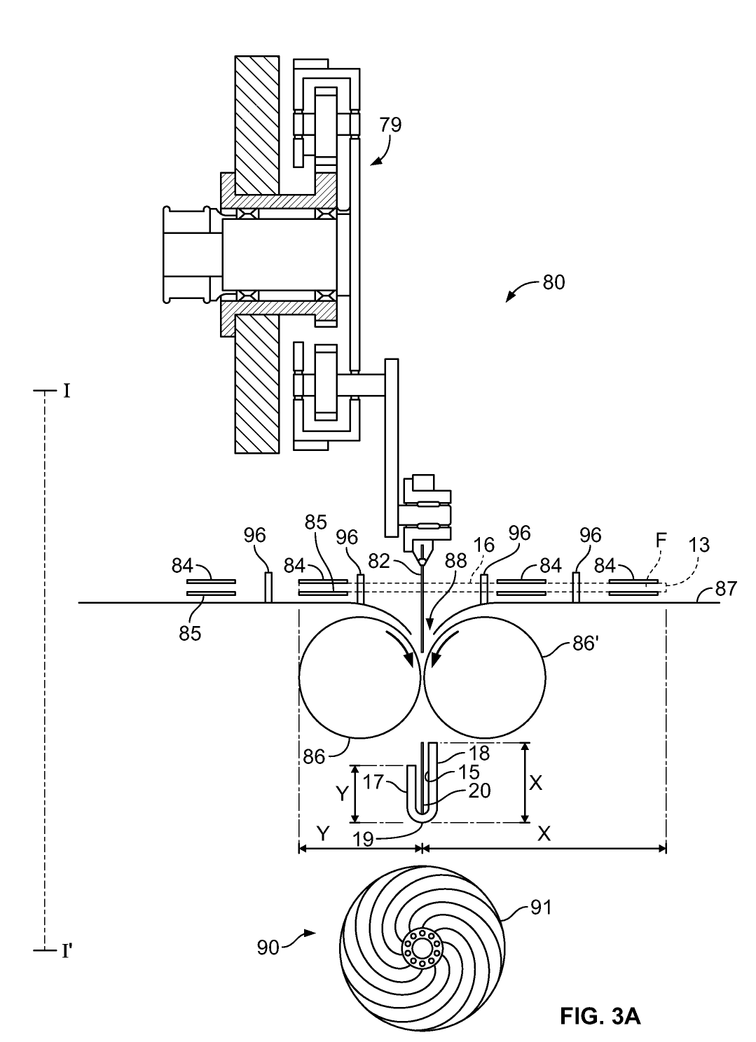

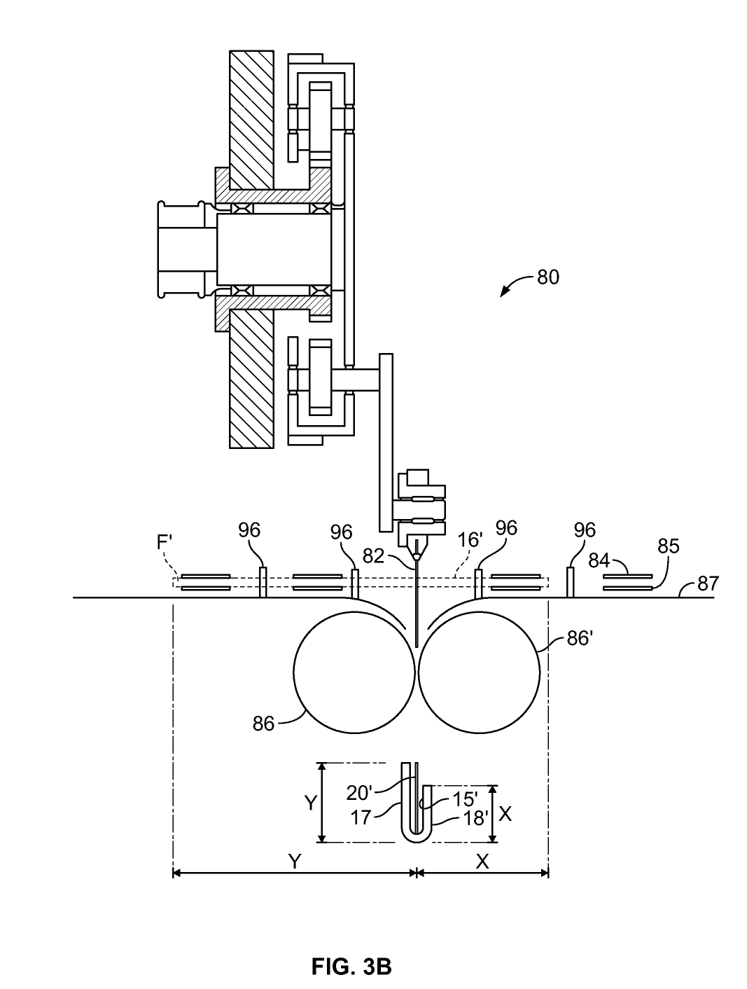

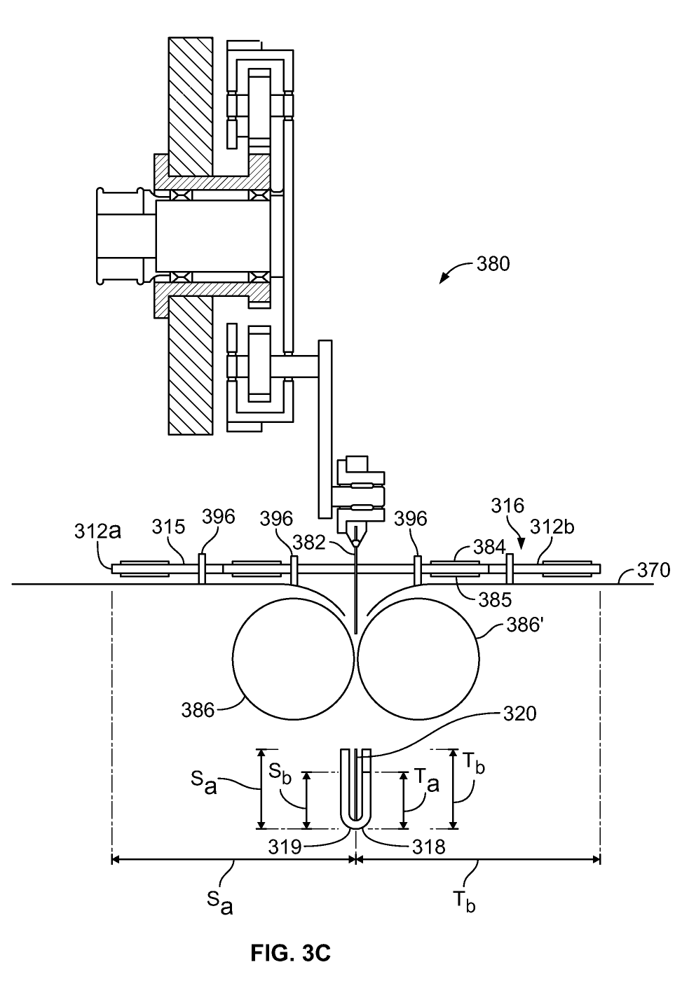

Jaws 66 of jaw cylinder 64 release folded newspapers 16 to conveying tapes 84, 85 headline down, with first fold F leading in the direction of travel. Quarterfolder 80 includes conveying belts or tapes 84, 85, cylinders 86, 86′, a folding blade 82 and a folding table 87. (FIG. 3A). Quarterfolder 80 quarterfolds folded newspaper 16 to produce an offset quarterfolded newspaper 18. Newspaper 16 may also be transported headline up as desired.

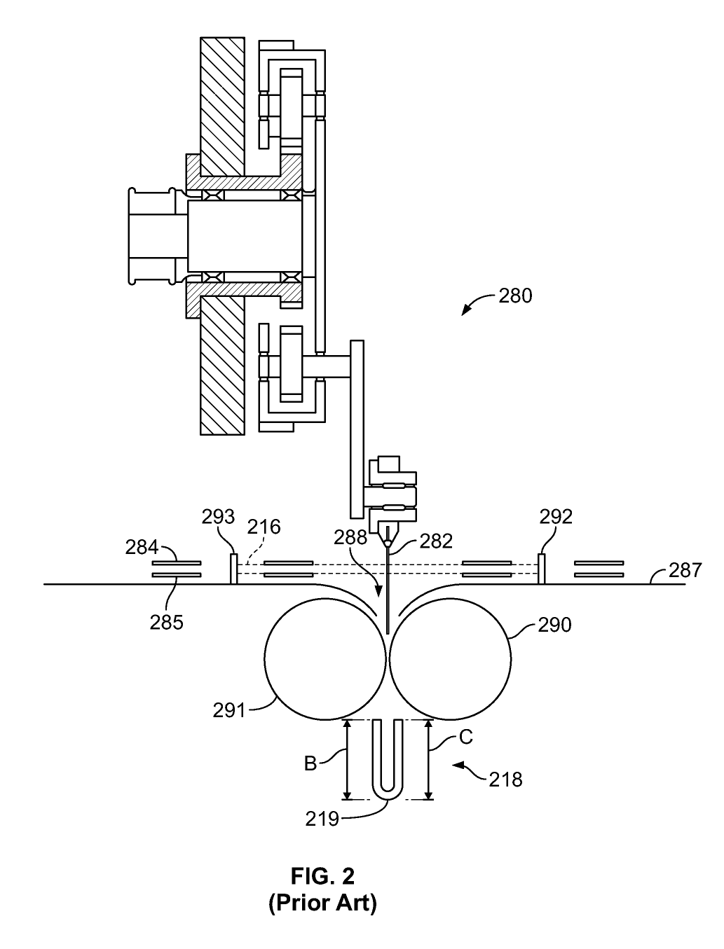

FIG. 2 shows a quarterfolder device according to the prior art. Quarterfolder device 280 may be similar to the quarterfolders disclosed in U.S. Pat. Nos. 6,551,228 and 4,509,939, hereby incorporated by reference herein. Quarterfolder 280 includes conveying tapes 284, 285 which convey a newspaper 216 in a direction out of the page until newspaper 216 reaches stops 292, 293. Stops 292, 293 are mounted to folding table 287. Stops 292, 293 gently contact the newspaper 216 to slow down and align newspaper 216. Immediately after contact, folding blade 282 comes down and forces newspaper 216 through a folding slot 288 in table 287. Newspaper 16 is pushed between folding cylinders 290, 291 which quarterfold newspaper 216 in half in the direction of travel. Quarterfolded newspaper 218 includes a quarterfold 219. A length C to the right of quarterfold 219 is approximately equal to a length B to the left of quarterfold 219. Thus quarterfolded newspaper 218 is essentially cross folded in half by a jaw cylinder then quarterfolded in half by quarterfolder 280.

The components of FIGS. 1 and 2 are driven in a conventional manner, and thus, the details of the drive system for these components will not be described herein.

FIGS. 3A to 3C show a quarterfolder device 80, 380 in accordance with preferred embodiments of the present invention. FIG. 3A shows a cross-section I-I′ of quarterfolder 80 shown in FIG. 1. The quarterfolder blade support 79 is not shown in FIG. 1 for simplicity. In FIG. 3A, conveying tapes 84, 85 transport newspaper 16 in a direction out of the page to folding table 87 of quarterfolding device 80. The first folded edge (cross fold) F of newspaper 16 leads newspaper 16 into quarterfolder 80. Folding table 87 includes a folding slot 88. Folding cylinders 86, 86′ are positioned underneath folding slot 88. A plurality of stops 96 are mounted on folding table 87. Quarterfolding blade 82 reciprocates down and up, into and out of folding slot 88.

Conveying tapes 84, 85 transport newspaper 16 until newspaper 16 gently contacts one or more stops 96. The stop 96 aligns and registers newspaper 16. Immediately thereafter, folding blade 82 moves down on newspaper 16 forcing newspaper 16 into folding slot 88 between folding cylinders 86, 86′. The contact between newspaper 16 and folding cylinders 86, 86′ creates a quarterfold 19 resulting in a quarterfolded newspaper 18. The quarterfold 19 is perpendicular to the first transverse cross fold F formed by jaw cylinder 64.

After leaving the folding cylinders 86, 86′, the quarterfolded newspapers are transported for further processing, for example, with a quarterfold delivery fan, or with guide tapes. A quarterfold delivery fan 90 is schematically illustrated in FIG. 3A. The fan blades 91 of the delivery fan 90 may have variable length extensions to accommodate different size newspapers, or the blades 91 may have a fixed length that is sufficient to accommodate an anticipated range of newspaper sizes.

The folding blade 82, conveying tapes 84, 85 and folding cylinders 86, 86′ are driven in a conventional manner, and thus, the details of the drive system for these components will not be described herein.

The lateral position of quarterfolder 80 with respect to newspaper 16 determines a position of quarterfold 19 since folding blade 82 folds newspaper 16 in the direction of travel. In FIGS. 3A and 3B, the direction of travel is into and out of the page, thus movement of quarterfolder 80 to the left or the right with respect to newspaper 16 will alter the location of quarterfold 19. As shown in FIG. 3A, a larger portion of newspaper 16 is transported by tapes 84, 85 to the right of blade 82. This length X from folding blade 82, may be, for example, 10.5 inches.

The 10.5 inch length may be desired to cover or protect inserts. Many inserts are 10.5 inches in height. By placing quarterfold 19, 10.5 inches from an top edge 13 of newspaper 16, a tabloid format newspaper may be quarterfolded into a small broadsheet so 10.5 inch inserts are covered and/or protected by one of the folded portions of the newspaper. If newspaper 16 were folded in half 10.5 inch inserts would protrude out a top of the newspaper. Protruding inserts make packing and transporting more difficult and are not appealing on typical newspaper display stands.

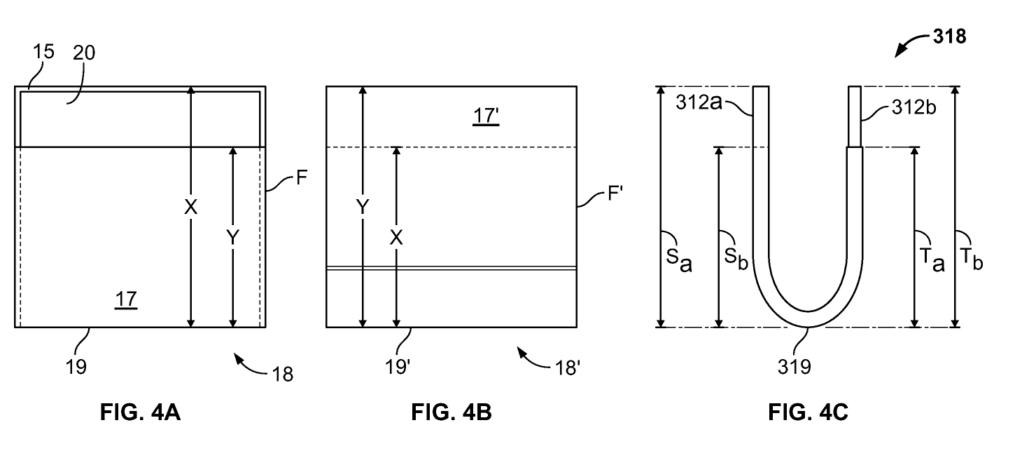

As shown in FIG. 3A and in FIG. 4A discussed below, when length X is 10.5 inches, the remaining length of newspaper 16 lays to the right of folding blade 82. This length, length Y, may be 1.5 to 9.5 inches for a total newspaper height between 12 and 20 inches. Length X may be adjusted to accommodate any size insert format or as desired. Length X is preferably between 10 and 11 inches. Length Y may be 8.0 inches for a newspaper having a total height of 18.5 inches. After quarterfolding, length Y creates a flap 17. Flap 17 may be folded up along quarterfold 19 so inserts 20 can be placed between flap 17 and a back page 15 of newspaper 16.

FIG. 3B shows another preferred embodiment according to the present invention. In this embodiment, newspaper 16′ is aligned so length Y is preferably 10.5 inches and length X represents the remaining length, for example, 8.0 inches. As shown in FIG. 3B and in FIG. 4B discussed below, first fold F′ created from jaw cylinder 64 leads newspaper 16′ into quarterfolder 80. A quarterfold 19′ is made perpendicular to first fold F′. A flap 17′ is folded against a back page 15′. Inserts 20′ may be placed between flap 17′ and back page 15′.

As shown in FIGS. 3A and 3B, newspapers 18, 18′ may be arranged so the back flap Y is shorter than the front of the folded newspaper X. Since the registration of newspapers 16, 16′ with respect to folding blade 82 is adjustable, newspapers 16, 16′ may also be quarterfolded in half as conventionally known using quarterfolder 80 as well. To quarterfold newspapers 16, 16′ in half, the length X to the right of quarterfolding blade 82 and the length Y to the left of quarterfolding blade 82 are approximately equal. Also, newspapers 16, 16′ may be quarterfolded so any lap desired may be obtained by positioning quarterfolder 80 with respect to former 40, jaw cylinder 62 and newspapers 16, 16′. The length of flaps 17, 17′ may thus be varied as desired.

FIGS. 3C and 4C show a further embodiment according to the present invention. In FIG. 3C, two superimposed ribbons 312a, 312b are displaced from one another and folded together in jaw cylinder 362 forming a first folded newspaper 316 have a first fold 315. Folded ribbons 312a, 312b are transported in a direction out of the page between conveying tapes 384, 385 with first folded edge 315 leading towards stops 396. Ribbons 312a and 312b are folded so ribbon 312a surrounds ribbon 312b. Due to the displacement, ribbon 312b extends out of ribbon 312a. Ribbon 312b is aligned so 10.5 inches of ribbon 312b lays to the right of folding blade 382, a length Tb. The remaining length of ribbon 312b lays to the left of folding blade 382, a length Sb. Ribbon 312a is aligned so 10.5 inches lay to the left of folding blade 382, a length Sa. The remaining length of ribbon 312a lays to the right of folding blade 382, a length Ta. Newspaper 316 is quarterfolded by folding blade 382 resulting in quarterfolded newspaper 318. Inserts 320 may be placed into newspaper 318. Inserts 320 remain inside newspaper 318 protected on both sides of quarterfold 319.

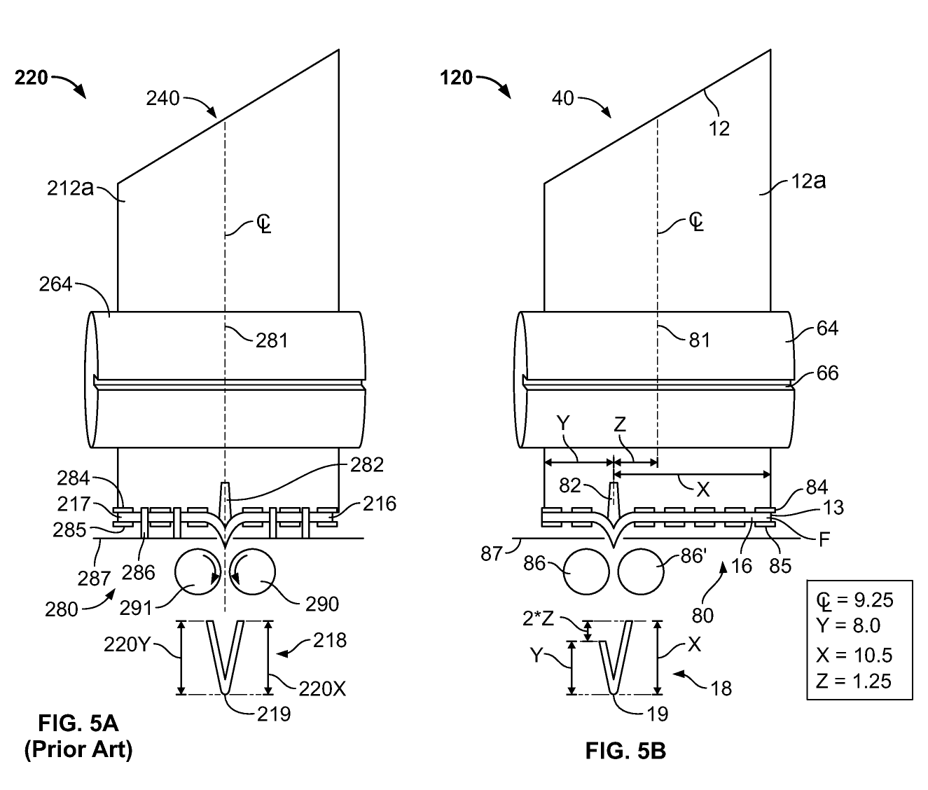

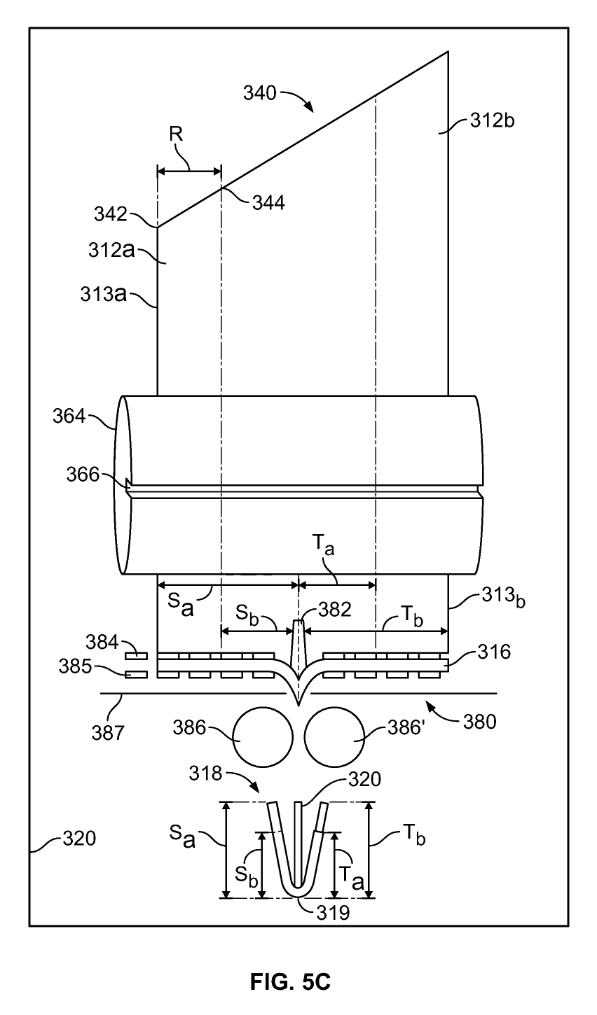

Due to the displacement of ribbon 312b with respect to ribbon 312a, newspaper 316 is essentially quarterfolded in half. Each ribbon 312a, 312b is quarterfolded offset with respect to each separate ribbon 312a, 312b. However, when looking at quarterfolded newspaper 318, newspaper 318 is essentially quarterfolded in half since 10.5 inches of ribbon 312a lay to the left of quarterfold 319 and 10.5 inches of ribbon 312b lay to the right of quarterfold 319. Quarterfolder 380 may be moved with respect to the position of newspaper 316, jaw cylinder 364 (FIG. 5C) and former 340 (FIG. 5C). Combining displacement of the ribbons with an adjustable position of quarterfolder 380 provides a multitude of possibilities for quarterfolded newspaper 318. Newspaper 318 may be quarterfolded so newspaper 318 is quarterfolded offset, in addition to ribbons 312a, 312b being quarterfolded offset. Furthermore, depending upon the displacement of one ribbon with respect to the other, one ribbon may be quarterfolded offset while the other ribbon is quarterfolded in half.

FIG. 4A shows a quarterfolded newspaper 18. Newspaper 18 was cross folded as shown by first fold F, then quarterfolded as shown by quarterfold 19. Flap 17 is folded against a back page 15 along quarterfold 19. Inserts 20 are placed between flap 17 and back page 15. Quarterfolded newspaper 18 has a length X which maybe for example, 10.5 inches, and flap 17 has a length Y, which may be for example, 8.0 inches. Lengths X and Y may thus be varied as desired to accommodate varying newspaper sizes and formats and varying insert sizes and formats. Length X is the length between top edge 13 of newspaper 18 and quarterfold 19, while length Y is the length between a bottom edge 11 of newspaper 18 and quarterfold 19. Exemplary values for the newspaper length, centerpoint of the newspaper length, X and Y (in inches) are shown in the table below, along with the percent offset from the centerpoint of the newspaper, which is defined herein as % offset=((Center−Y)/Paper Length)*100:

| Paper Length | X | Y | Center | % offset |
|---|---|---|---|---|
| 12 | 10 | 2 | 6 | 33.33% |
| 12 | 10.5 | 1.5 | 6 | 37.50% |
| 12 | 11 | 1 | 6 | 41.67% |
| 14.67 | 10 | 4.67 | 7.335 | 18.17% |
| 14.67 | 10.5 | 4.17 | 7.335 | 21.57% |
| 14.67 | 11 | 3.57 | 7.335 | 25.66% |
| 18.5 | 10 | 8.5 | 9.25 | 4.05% |
| 18.5 | 10.5 | 8 | 9.25 | 6.76% |
| 18.5 | 11 | 7.5 | 9.25 | 9.46% |
| 20 | 19 | 1 | 10 | 45.00% |
| 20 | 10.5 | 9.5 | 10 | 2.50% |
| 20 | 11 | 9 | 10 | 5.00% |
| 22 | 21 | 1 | 11 | 45.45% |
| 22 | 12 | 10 | 11 | 4.55% |

FIG. 4B shows a quarterfolded newspaper 18′. Newspaper 18′ was cross folded as shown by first fold F′, then quarterfolded as shown by quarterfold 19′. Flap 17′ is folded against a back page 15′ along quarterfold 19′. However, the length Y′ of flap 17′ is greater than the length X′ of back page 15′. For example, length Y′ may be, for example, 10.5 inches, and length X′ may be, for example, 8.0 inches. Inserts 20′ may be placed between flap 17′ and back page 15′. (FIG. 3B).

FIG. 5A shows a folder 220 arrangement known in the prior art. FIGS. 5B to 5C show preferred embodiments of folders 120, 320 in accordance with the present invention. In FIG. 5A, a quarterfolded newspaper 218 is formed by slitting a web into ribbons as the web runs over a nose of a former 240. Ribbon 212a is cut by a cutting cylinder (not shown) and cross folded in a jaw cylinder 264 as described above in connection with FIG. 1. Conveying tapes 284, 285 transport folded newspapers 216 from jaw cylinder 264 to quarterfolder 280. Former 240, quarterfolder 280, ribbon 212a and subsequent newspapers 216 are aligned with respect to a center axis, centerline 281. A folding blade 282 is aligned with centerline 281 to impart a fold in a center of newspaper 216. Newspaper 216 moves in a direction out of the page and aligns with stops 286 on folding table 287 as shown. Immediately after contact with stops 286, folding blade comes down on newspaper 216 and pushes newspaper 216 through a folding slot in folding table 287 between folding cylinders 290, 291 thereby quarterfolding newspaper 216 in half. Quarterfold 219 is perpendicular to first fold 217 formed in jaw cylinder 262. Since quarterfolder 280 and folding blade 282 are aligned with center axis 281, quarterfolder 280 folds newspapers 216 in half. A length 220X to the right of quarterfold 219 and a length 220Y to the left of quaterfold 219 are thus equal or very nearly equal.

FIG. 5B shows a preferred embodiment of an arrangement of folder 120 including former board 40 and quarterfolder 80 in accordance with the present invention. A web 12 running over former 40 is slit into ribbons 12a, 12b by a slitter on a nose of former 40 (FIG. 1). Ribbons 12a, 12b are cut by a cutting cylinder 50 (not shown) and cross folded in a jaw cylinder 64 to form a first fold F in folded newspaper 16. Conveying tapes 84, 85 transport folded newspaper 16 in a direction out of the page to quarterfolder 80. Former 40, ribbon 12a and jaw cylinder 64 are aligned along a central axis, centerline 81. Quarterfolder 80 and folding blade 82 are not centrally aligned along centerline 81. Quarterfolder 80 and folding blade 82 are displaced to the left of centerline 81 by an offset distance Z which may be adjustable. Moving quarterfolder 80 to the left or right adjusts the value of Z and shifts the position of quarterfold 19 imparted by folding blade 82. Folding blade 82 contacts newspaper 16 at a length Y from a top edge of newspaper 16 and a length X from a bottom edge of newspaper 16, length X is greater than length Y by a length of two times the offset distance Z, 2*Z. Thus, quarterfold 19 does not fold newspaper 18 in half. Length X may be, for example, 10.5 inches, and length Y, may be, for example, 8.0 inches.

If quarterfolded newspaper 18 was folded in approximately half as shown in the prior art, each side would be approximately 9.25 inches long. Offsetting quarterfolder 80 by a length Z, for example, 1.25 inches to the left, provides a quarterfolded newspaper 18 having a length Y, for example, 8.0 inches to the left of quarterfold 19 and a length X, for example, 10.5 inches, to the right of quarterfold 19. The difference between a length X and a length Y is equal to 2 times length Z. Thus, 10.5 inches (X) minus 8.0 (Y) inches equals 2.5(2*Z) inches. Length Z equals 1.25 inches, multiplied by two, equals 2.50 inches. By offsetting quarterfolder 80 from a centerline 81 of former 40 and newspaper 16 an offset quarterfolded newspaper 18 may be produced.

As shown in FIG. 5C, another preferred embodiment in accordance with the present invention includes pulling ribbons, for example, ribbon 312b, off former 340 before ribbon 312b reaches a nose 342 of the former 340. In FIG. 5C, ribbons 312a, 312b may be slit from the same web at a location upstream of former 340, for example, at a slitter before or after entering a folder 320. Alternatively, ribbons 312a and 312b could be printed on different printing presses and run via angle and turner bars into folder 320. In this case, ribbon 312a may still be slit at a nose 342 of former 340, however, ribbon 312b will be slit to the proper size prior to running across former 340.

Ribbon 312a runs down former 340 similar to ribbon 12 as discussed above. Ribbon 312b is combined with ribbon 312A and runs down former 340 on top of ribbon 312a. Ribbon 312b is pulled off former 340 at a location 344 upstream of nose 342. Pulling ribbon 312b off former 340 before reaching nose 342 displaces ribbon 312b a distance R away from an edge 313a of ribbon 312a. Distance R may be, for example, 2.5 inches.

Thus when ribbons 312a, 312b exit former 340, ribbon 312b is displaced 2.5 inches (distance R) from edge 313a of ribbon 312a. Ribbons 312a and 312b move through folder in a similar manner as described above with respect to ribbons 12a and 12b shown in FIG. 5B.

Ribbons 312A, 312B are cut into newspapers by a cutting cylinder (not shown) and cross folded in a jaw cylinder 364 to form a first fold 315 and a folded newspaper 316. Conveying tapes 384, 385 transport folded newspaper 316 to quarterfolder 380. Former 340 and jaw cylinder 362 are aligned along a central axis.

Quarterfolder 380 and folding blade 382 are positioned at a desired folding location, preferably 10.5 inches or more from edge 313a of ribbon 312a and 10.5 inches or more from an edge of 313b of ribbon 312b. The position of quarterfolder 380 is movable with respect to jaw folder 362 and former 340 in order to change the location of quarterfold 319. In this example, quarterfolder 380 is shifted 1.25 inches to the right of the central axis to shift the position of quarterfold 319 imparted by folding blade 382. Folding blade 382 contacts newspaper 16 a length Sa from an edge 313a of ribbon 312 and a length Tb from an edge 313b of ribbon 312b. In this example, both Sa and Tb equal a distance of 10.5 inches. Thus, the remaining length Ta of ribbon 312a to the right of folding blade 382 and a remaining length Sb of ribbon 312b to the left of folding blade 382 both equal 8.0 inches since each ribbon has a total length of 18.5 inches.

By moving quarterfolder 380 to the right 1.25 inches an offset quarterfold is produced in both ribbons 312a and 312b. By shifting ribbon 312b to the right 2.5 inches with respect to ribbon 312a, a quarterfolded newspaper 318 is produced having a total height of 21.0 inches, (length Sa plus length Tb). In this example, the displacement of ribbon 312b with respect to ribbon 312a provides a newspaper 318 that is essentially quarterfolded in half, however, each ribbon 312a, 312b is quarterfolded offset. The total length Tb of newspaper 318 to the right of quarterfold 319 is equal to the total length Sa of newspaper to the left of quarterfold 319, both length Sa and length Tb being 10.5 inches. By providing a newspaper with 10.5 inches on either side of quarterfold 319, standard-sized inserts 320 may be placed in newspaper 318 without protruding yet still being protected by both sides of newspaper 318. Other variations may be designed so both ribbons 312a, 312b and newspaper 318 are offset quarterfolded.

A total height of newspapers 16, 16′, 316 may be dependent upon the existing press, width of web or desired format. A total width of newspapers 16, 16′, 316 on a tabloid style press may be dependent upon the length of the printing plates and/or circumference of the plate cylinders and is typically fixed on the printing press.

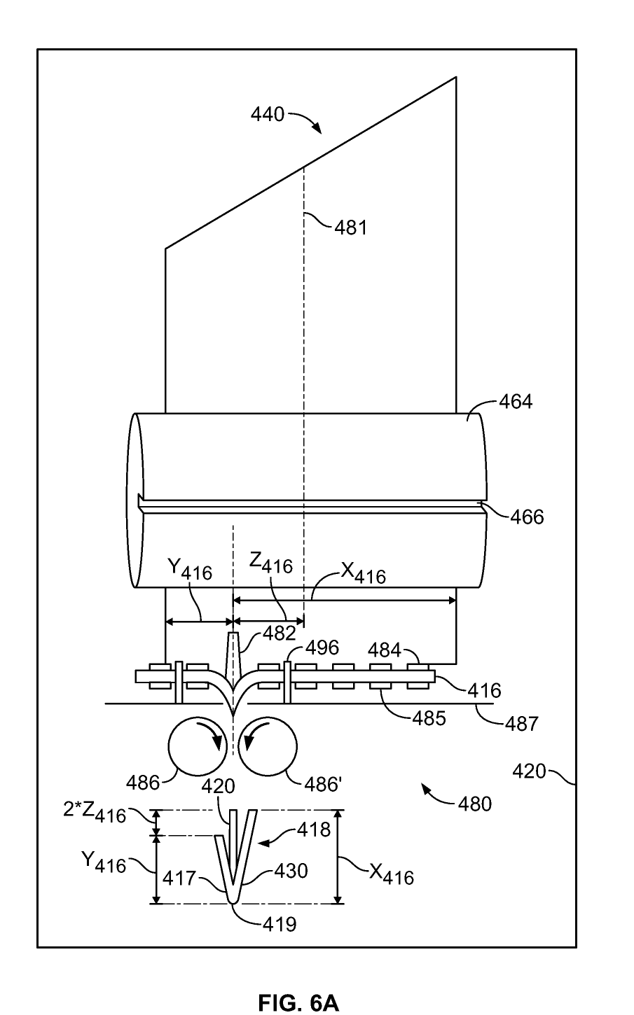

Another preferred embodiment in accordance with the present invention includes a newspaper having a total length of, for example, approximately 14.67 inches. As shown in FIG. 6A, newspaper 416 may be quarterfolded so 10.5 inches of newspaper 416 lays to the right of folding blade 482 and the remaining length, 4.17 inches, lays to the left of folding blade 482. In this example, flap 417 is approximately 28.4% the total height of newspaper 416 (4.17/14.67=28.4%). Thus, flap 417 may be noticeably smaller than flap 17 discussed above and shown in FIG. 3A.

In FIG. 6A, newspaper 416 is traveling towards stops 496 in a headline down position with first fold 415 leading. Quarterfolder 480 is shifted from a centerline 481 folding position 3.165 inches to the left, an offset distance Z₄₁₆. In this shifted position, quarterfolder 480 imparts a quarterfold 419 into newspaper 416 at position 10.5 inches from the top edge of newspaper 416, a length X₄₁₆, producing quarterfolded newspaper 418 which includes a 10.5 inch front section 430 and 4.17 inch back flap 417, 4.17 inches being the remaining length, length Y₄₁₆, to the left of folding blade 482. The difference in length between front section 430 and flap 417 is two times the offset distance Z₄₁₆. Thus, front section 430 has a length X₄₁₆ equal to 10.5 inches, and flap 417 has a length Y₄₁₆ equal to 4.17 inches, the different being 6.33 inches, which is two times offset distance Z₄₁₆, 3.165 inches. After the newspaper is folded, inserts 420 may be subsequently placed inside newspaper 418 between front section 430 and flap 17 without protruding. As shown in FIGS. 6A, 5B and 5C adjusting the position of quarterfolders 480, 80 and 380 respectively can produce a plurality of quarterfolds and a plurality of quarterfolded products.

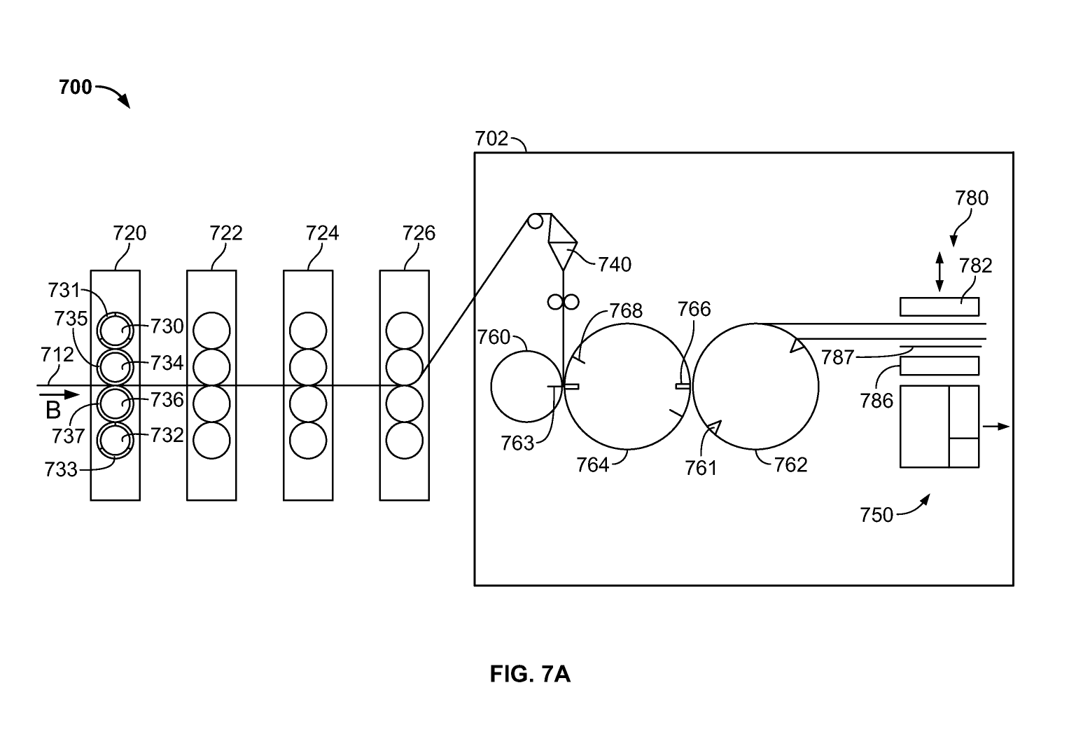

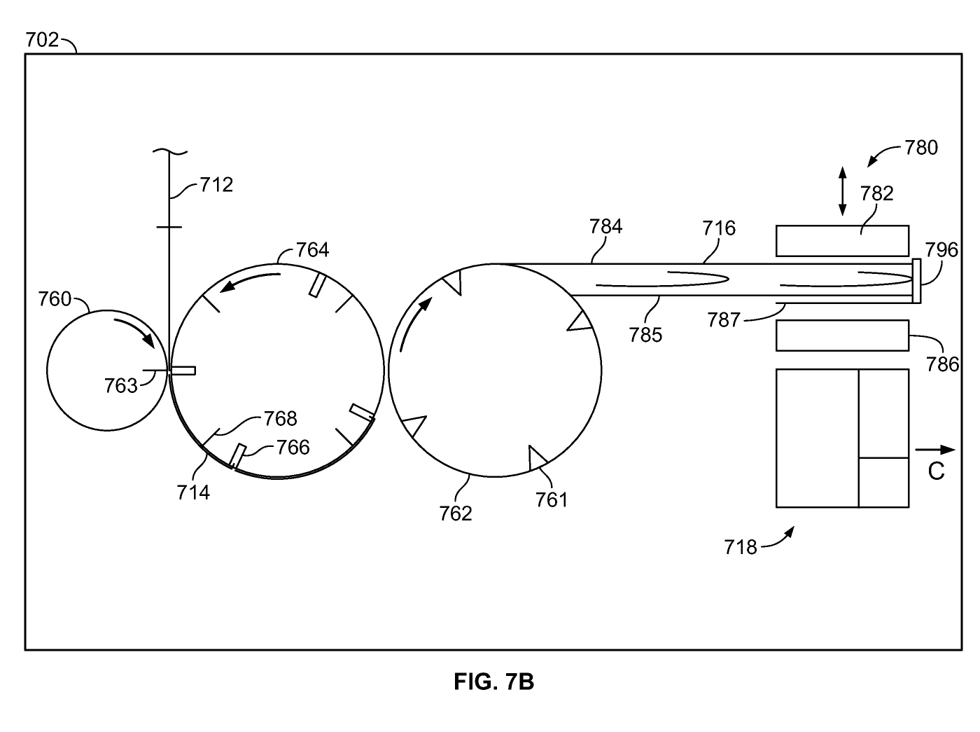

FIG. 7A shows a printing press 700 for printing broadsheet newspapers in accordance with another preferred embodiment of the present invention. Printing press 700 includes a folder section 702 and a quarterfolding device 780 shown in more detail in FIG. 7B. The broadsheet printing press 700 may be a perfecting, web offset, four color printing press. Printing press 700 May include four printing units 720, 722, 724, 726 each printing on a web 712 with a different color ink, for example, cyan, magenta, yellow and black. Web 712 travels through press 700 in a direction B from printing unit 720 to folder section 720.

Each printing unit 720, 722, 724, 726 includes two printing cylinders 730, 732 and two blanket cylinders 734, 736. Each printing cylinder 730, 732 carries three printing images 731, 733. Printing cylinders 730, 732 may have, for example, a 44 inch circumference. Alternatively, the printing cylinders 730, 732 may carry only one image around each. Printing plates may be mounted on printing cylinders 730, 732 or printing cylinders 730, 732 may be etched or imaged directly. Each blanket cylinder 734, 736 includes a printing blanket 735, 737 mounted thereon. The printing blankets 735, 737 may be flat blankets mounted into a lockup mechanism or printing blankets 735, 737 may be tubular, gapless, sleeve-shaped blankets. The printing plates 731, 733 transfer images to printing blankets 735, 737 which transfer images to web 712.

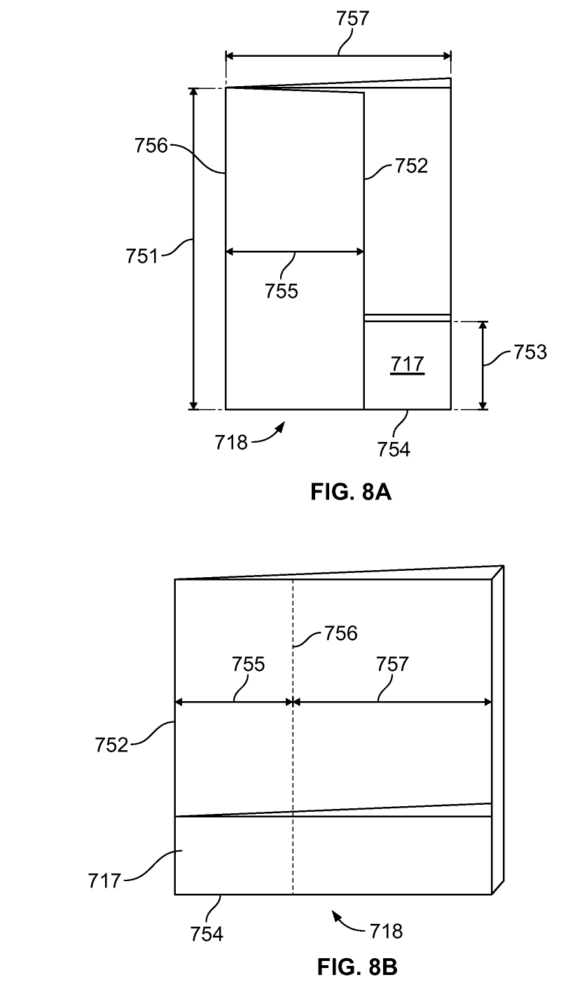

Web 712 then enters folder section 702 as shown in more detail in FIG. 7B. Folder section 702 includes a triangular shaped former 740 for folding web 712 longitudinally in half, in the direction of travel, creating a first fold 752 (shown in FIGS. 8A and 8B). Web 712 may also be combined with other web ribbons for simultaneous folding and slitting. A cutting roller 760 cuts web 712 into newspapers 714. Folding cylinders including jaw cylinder 762 and tucking cylinder 764 subsequently fold newspaper 714. A gripper 766 located on tucking cylinder 764 grips a leading edge of newspaper 714. Grippers 766 may be pins or pinless grippers. A tucking blade 768 on tucking cylinder 764 tucks newspaper 714 into a jaw 761 on jaw cylinder 762 creating a second fold 754 of newspaper 714. The second fold 754 is a transverse cross fold, perpendicular to the direction of travel. Cross fold 754 may be an offset cross fold. Thus, tucking blade 768 may not fold newspaper 714 in half. As shown in FIGS. 8A and 8B, tucking blade 768 may fold newspaper 14 so a length 751 of at least one face of newspaper 716 has a length of, for example, 10.5 inches or more. Another face of newspaper 716 may have a shorter length 753 and form a flap 717 when folded up. A folder for producing an offset cross fold is described in U.S. Patent Publication 2007/0161486, which is hereby incorporated by reference.

Jaws 761 release folded newspapers 716 to conveying tapes 784, 785, with second cross fold 754 leading in the direction of travel, newspaper 716 is transported headline down to quarterfolder 780. Quarterfolder 780 includes conveying belts or tapes 784, 785, cylinders 786 a folding blade 782 and a folding table 787. Quarterfolder 780 quarterfolds folded newspaper 716 to produce an offset quarterfolded newspaper 718. Thus, in newspaper 718, cross fold 754 may be offset and quarterfold 756 also may be offset. Offset quarterfolded newspapers 718 may be transported further downstream in a direction C via a conveyor.

A position of quarterfolder 780 may be adjusted with respect to newspaper 716 in order to adjust or modify the position of quarterfold 756. Quarterfolder 780 may be adjusted similarly to quarterfolder 80 and 380 discussed above. Thus, quarterfold 780 may quarterfold newspaper 716 in half or offset. In addition, jaw cylinder 762 and tucking cylinder 764 may be set to cross fold newspapers 714 in half or offset as desired. Thus, a broadsheet newspaper may be formed with a symmetrical cross fold and quarterfold or with an offset cross fold and offset quarterfold or any combination thereof.

FIGS. 8A and 8B show quarterfolded newspaper 718 including an offset cross fold 754. Offset cross fold 754 is created by folding cylinders 762, 764. A length 751 of newspaper face 757 may be, for example, 10.5 inches, while a length 753 of flap 717 may be, for example, less than 10.5 inches, preferably 8.0 inches or 4.17 inches. In addition, quarterfold 756 may also be an offset fold. A width 757 across a face of newspaper may be greater than a width 755 across a second flap defined by quarterfold 756.

In the embodiments described above with regard to FIGS. 3A, 3B, 5B, 6A, and 7B, the quarterfold offset is determined by the relative position of the newspaper (16, 16′, 416, 716) and the quarterfolder 780. In applications in which this relative position need not change, the relative position can be fixed upon installation. Alternatively, the relative position can be adjustable. For example, quarterfolder may be movably mounted relative to the conveying tapes. For example, the quarterfolder may be movably mounted in a frame so that it can be moved left or right (from the perspective of FIGS. 3A, 3B, 5B, 6A, and 7B). Movement of the quarterfolder can be accomplished manually, or under the control of a motor, for example. Alternatively, the conveying path of the conveying tapes may be adjustable to change the relative position of the newspaper (16, 16′, 416, 716) and the quarterfolder 780. As another alternative, the former 40 could be moved forward or backward, thereby changing the lateral position of the ribbon in the folding cylinder and thus the position of the folded newspaper relative to the quaterfolder. Again, this adjustment can be manually, or under the control of a motor, for example.

In some applications in which the relative position of the newspaper (16, 16′, 416, 716) and the quarterfolder 780 is varied, it may also be desirable to vary the speed of the folding cylinders 290, 291 as a function of the length “x” of the folded newspaper. For example, referring to FIG. 3, if a newspaper has a height of 12 inches, and is quarterfolded to provide a flap 17 having a length of 2 inches, a 10 inch folded newspaper will need to pass through folding cylinders 290, 291. In contrast, if the same newspaper is folded to provide a flap 17 having a length of 4 inches, then a 6 inch folded newspaper will need to pass through folding cylinders 290, 291. It would therefore be desirable for the folding cylinders to rotate at a slower speed to deliver the 6 inch folded newspaper than to deliver a 10 inch folded newspaper. This change in speed could be implemented manually by setting the appropriate speed, or be selected from a table of values from a user interface. Alternatively, the speed could be adjusted automatically based on the position of the folding blade 82 relative to the conveying path.

Although the cross folder is illustrated in FIGS. 1 and 7b as having a collect cylinder and folding cylinder, other types of cross-folders can alternatively be employed. For example, a folder employing rotary tuckers and folding rollers, a so-called rotary blade folder, can be used to create the cross fold. In that case, the jaw cylinder is replaced by folding rollers which receive the folded signatures from a tucker cylinder. U.S. Pat. No. 6,688,224 for example is hereby incorporated by reference herein as showing a rotary blade folder.

Although the embodiments described above have been illustrated with respect to newspapers, one of ordinary skill in the art will appreciate that it can be applied to other folded products as well. Further, although the present invention is particularly useful for creating a folded newspaper having a height sufficient to cover a typical 10 to 11 inch newspaper insert, it can be used to produce a wide variety of custom folded products. For example, the present invention would be used in conjunction with a perforator, with the lap 17 corresponding to a perforated advertisement or other item designed to be torn out of the folded product.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An apparatus for imparting a fold to a printed product comprising:
a conveyor conveying a printed product in a path, the printed product having a centerpoint along a length of the printed product extending in a direction perpendicular to the path;
a folding blade for folding the printed product along a fold which is parallel to a direction of the path;
a pair of folding cylinders for receiving the printed product folded by the folding blade;
the folding blade and folding cylinders being positioned with respect to the path so that the fold is offset from the centerpoint by at least 2.5% of the length, and no more than about 45% of the length.

2. The apparatus of claim 1; wherein the printed product is a newspaper and the fold is a quarterfold.

3. The apparatus of claim 1, wherein the length is 12 inches and the fold is offset from the centerpoint by at least 1 inch and no more than about 5 inches.

4. The apparatus of claim 3, wherein the fold is offset from the centerpoint by at least 3 inches and no more than about 5 inches.

5. The apparatus of claim 1, wherein the length is between about 14 inches and about 15 inches and the fold is offset from the centerpoint by at least 1 inch and no more than about 5 inches.

6. The apparatus of claim 5, wherein the fold is offset from the centerpoint by at least 2 inches and no more than about 3 inches.

7. The apparatus of claim 1, wherein the length is between about 18 inches and about 20 inches and the fold is offset from the centerpoint by at least 0.5 inches and no more than about 9 inches.

8. The apparatus of claim 7, wherein the fold is offset from the centerpoint by at least 1 inch.

9. A newspaper printing press comprising:
at least one print unit printing at least one web of material; and
a folder including:
a cross folder for forming a cross-fold in the newspapers; and
a quarterfolder having a folding blade, the quarterfolder receiving the cross-folded newspapers at the cross-fold, a folding location of the quarterfolder being adjustable with respect to the cross-folded newspapers so that the fold is offset from a center of the crossfolded newspaper by at least 2.5% of the length, and no more than about 45% of the length.

10. The newspaper printing press as recited in claim 9. wherein the folding location is located at approximately 10.5 inches from an edge of the newspaper so as to create a newspaper having a first side with a height of at least approximately 10.5 inches and a second side with a height of approximately 8.5 inches or less.

11. The newspaper printing press as recited in claim 10, wherein the second side has a height of approximately 1.5 inches.

12. The newspaper printing press as recited in claim 9 wherein the folding location is located at between about 10 inches and about 11 inches from an edge of the newspaper so as to create a newspaper having a first side with a height of at between about 10 inches and about 11 inches and a second side with a height of approximately 9 inches or less.

13. The newspaper printing press as recited in claim 12, wherein the second side has a height of between about 1 inch and about 2 inches.

14. The newspaper printing press as recited in claim 12, wherein the second side has a height of between about 7 inches and about 8 inches.

15. The newspaper printing press as recited in claim 9, wherein the cross folder comprises a collect cylinder and a folding cylinder.

16. The newspaper printing press as recited in claim 15, wherein the folding cylinder is a jaw cylinder.

17. newspaper printing press as recited in claim 9, wherein the cross folder comprises a rotary blade folder.

18. A method for forming a newspaper comprising the steps of:
cross-folding a newspaper at a cross fold approximately in half;
quarterfolding the cross-folded newspaper with a folding blade at a quarterfold to create a newspaper having a first side having a predetermined first length from the quarterfold to an edge of the newspaper and a second side having a predetermined second length from the quarterfold to another edge of the newspaper, a ratio of the first length to the second length being at least 10.5 to 8.50.

19. A method for forming a newspaper comprising the steps of:
cross-folding a newspaper at a cross fold approximately in half;
quarterfolding the cross-folded newspaper with a folding blade at a quarterfold, the quarterfold being approximately 10.5 inches from an edge of the newspaper so as to create a newspaper having a first side with a length of at least approximately 10.5 inches and a second side with a height of approximately 8.50 inches or less.

20. An offset quarterfolded broadsheet newspaper comprising:
a longitudinal first fold located at a first fold location, the longitudinal first fold folding the newspaper in two approximately equal parts;
a cross fold located at a cross fold location, the cross fold location being offset from a center of the longitudinally first folded newspaper, the cross fold folding the newspaper in two unequal parts; and
a quarterfold located at a quarterfold location, the quarterfold location being offset from a center of the cross-folded newspaper, the quarterfold folding the newspaper in two unequal parts.

21. A newspaper comprising printed material, the newspaper having a total height of approximately 18.5 inches and a quarterfold at approximately 10.5 inches from a top or bottom edge of the newspaper.
